(19) United States
(12) Patent Application Publication
(10) Pub. No.: US 2006/0186623 A1
(43) Pub. Date: Aug. 24, 2006

(54) Trolley device

(76) Inventors: Gordon C Cox, Northhamptonshire (GB); Michael A Cox, Northamptonshire (GB)

Correspondence Address: CONNOLLY BOVE LODGE & HUTZ LLP, SUITE 800, 1990 M STREET NW, WASHINGTON, DC, 20036-3425, US

(21) Appl. No.: 10/537,815

(22) PCT Filed: Dec. 8, 2003
(86) PCT No.: PCT/GB03/05342

§ 371 Date: Dec. 15, 2005

(30) Foreign Application Priority Data
Dec. 7, 2002 (GB) 0228615.1
Aug. 22, 2003 (GB) 0319791.0

(51) Int. Cl. B62B 1/00

(52) U.S. Cl. 280/47.17; 280/47.19

(57) ABSTRACT

A trolley device capable of lifting and moving an open topped container, comprising a body part having handle means and means which permit movement of the device along a surface, the body part having primary container-contactable means including at least one container-contactable part located above ground level when said body part is upright which can engage a lower external side of such a container, and secondary container contactable means including at least one container-contactable part spaced above the said primary contacting means when said body part is upright and which can engage an upper internal side of the container, said body part capable of pivoting about the said means which permit movement to raise both said container-contactable means.

This invention is concerned with a trolley device. More particularly the invention is concerned with a trolley device intended for moving containers, particularly rimmed containers and more particularly open-topped garden containers from one position to another.

Container gardening has increased in popularity over the years, the growth in popularity encouraged by media coverage directed to gardening activities and also by numerous books and magazines. Virtually all garden centres supply an extensive range of pots and similar gardening containers to suit different tastes and types of gardens.

When these containers are filled with material such as soil or compost and especially when holding a growing shrub or other plant, they become heavy and hence difficult or awkward to move around manually. Frequently more than one person is required to lift and move a filled container from one location to another. There is a need for such filled containers to be moved around as a result of seasonal changes, the need to replenish soil or to replace plants and shrubs, or simply to provide a more attractive appearance.

In particular, when medium sized or larger pots or containers have been filled with soil they become difficult and awkward to move even more so when they contain well established plants or shrubs. Displacing such filled open-topped containers from one location to another therefore risks discomfort or possible injury to persons lacking appropriate physical strength, the elderly and people tending to suffer back pain. This problem in moving filled containers is greater when the containers are already located in saucers or trays having an external lip projecting above ground level, frequently the case when containers such as plant or shrub pots are situated on decking or within conservatories. Moreover garden centres and other retail outlets also need regularly to move individual display pots around. It is accordingly an object of the present invention to provide a trolley device which provides assistance in the lifting and moving of containers, particularly pots containing soil and or compost with or without plants or shrubs therein. In particular the present invention seeks to provide such a trolley device capable of lifting and moving such containers by one operative and with a minimum of physical effort.

According to this invention there is provided a trolley device capable of lifting and moving a container, comprising a body part having handle means and means which permit movement of the device along a surface, the body part having primary container-contactable means including at least one container-contactable part located above ground level when said body part is upright which can engage a lower external side of such a container, and secondary container contactable means including at least one container-contactable part spaced above the said primary contacting means when said body part is upright and which can engage an upper internal side of the container, said body part capable of pivoting in a manner to raise both said container-contactable means.

The body part preferably comprises an elongate length of tubing such as metal tubing, which may have for example a rectangular or square cross-section. The body part may comprise a plurality of such elongate tubular members which further may preferably be located in a framework wherein a plurality of elongate tubular members are generally parallel. The handle means conveniently comprises a handle portion in the form of an elongate length of tubing which is attached to the body part or which may alternatively comprise an integral part thereof. The handle means may further comprise, at its remote end, gripping means such as a rubber or foamed sleeve. The means which permit movement of the device may comprise a wheeled chassis, for example a pair of opposing plate members can be spaced apart and connected to form a generally rectangular housing, in which an axle is located, with wheels provided at the remote ends of the axle. Such a wheeled chassis can either be separate from the body part in which case it is conveniently attached thereto by bolts or other suitable fasteners, or alternatively it may comprise an integrally formed part of the said body part. For ease of use and ease of manufacture it is however generally preferred for the said means which permit movement of the device along the surface to comprise a separately attachable wheeled chassis. Such wheeled chassis is most conveniently adapted to permit conversion of the trolley device from a light duty embodiment to a heavy duty embodiment. For instance, in such a heavy duty embodiment additional lengths of elongate tubing can be affixed to opposing ends of the chassis part whereby the body part becomes an arrangement incorporating three generally parallel elongate lengths of tubing within a framework. Whilst wheels are preferred for such a chassis, other means for permitting transport of the device along the surface could be substituted. It is preferable for the body part to be capable of pivoting about the means which permit movement, for example the body part can swivel about such a wheeled chassis.

The primary container-contactable means preferably comprises a pair of projecting spigots, which may extend from one surface of such a wheeled chassis. For example such primary container-contactable means can comprise short lengths of hollow tubing or preferably solid section material such as steel being either round or square cross-section and fitted at their ends spaced from the chassis with frictional grips such as rubber ferrules which in use are adapted to engage an external lower side of an open-topped container such as a plant pot. Most preferably, the primary container-contactable means comprise elongate sections of solid round section steel, reduced at one end to pass through the chassis sections with a distance piece between and secured with a washer and locknut. This method of assembly adds stiffness to these load bearing members of the device. In such arrangement, the container-contactable parts of the primary container-contactable means comprise the said frictional grips. When the trolley device is positioned with the means which permit movement in contact with the ground and such that the body part is upright, such container-contactable parts of the primary container-contactable means are spaced above ground level. Conveniently such container-contactable parts of the primary container-contactable means remain in fixed position relative to the wheeled chassis if present, and relative to the body part. In alternative arrangements, the said primary container-contactable means may be moveable with respect to the said wheeled chassis and body part.

As already indicated above the most preferred containers to be used with the device include open-topped containers such as plant or shrub pots which contain significant soil and/or compost together with a shrub or similar plant material. Preferably the lower external side of the pot to be engaged by the said container-contactable parts of the primary container-contactable means comprises surface parts around the external circumference of the container, a short distance above ground level.

The secondary container-contactable means preferably comprises a moveable carriage whose position relative to the body part can be varied. The secondary container-contactable means can be displaceable along a length of the body part so that the distance between the preferably fixed primary container-contactable means and the secondary container-contactable means can be varied whereby a variable spacing between the two container-contactable means is provided. The secondary container-contactable means includes at least one but preferably two container-contactable-parts which, when the body part is upright, are located above the said primary contacting means. The container-contactable part or parts of the secondary container-contactable means preferably comprise hook members. A pair of similar hook members can be affixed to one part of the secondary container-contactable means. For example, such hook members can be securely fastened to a plate member which forms part of a moveable carriage. The hook members preferably have remote ends spaced from the moveable carriage and which are directed inwardly towards the body part of the device, whereas the remote ends of the container-contactable parts of the primary container-contactable means preferably project outwardly with respect to the said body part.

Such hook members are preferably arranged whereby the said remote ends are arranged to permit contact with an internal upper side of an open-topped container. For example, these container-contactable parts of the secondary container-contactable means may comprise prongs positioned relative to the body part to engage internal upper circumferential parts of an open topped container such as a pot. Preferably such parts of the open-topped container are internal surfaces situated just below a rim on the internal sidewall of the container.

It is preferred that one of the container-contactable means is moveable relative to the other along the said body part. It is also preferred that the said one of the container-contactable means which is moveable, comprises a moveable carriage. Such moveable carriage preferably incorporates a releasable clamp mechanism.

Such clamp mechanism, where provided, is preferably releasably spring-urged in frictional engagement with the body part to maintain its selected position on the body part and resist displacement therefrom until required by a user of the device.

The secondary container-contactable means are preferably moveable linearly along the body part towards and away from the preferably fixed primary container-contactable means. Moveable secondary container-contactable means, where provided, are preferably adapted to be displaced along the said body part by a hand or foot operable member such as a pivoting plate, or by other means such as a lever extending in the region of the handle means.

The secondary container-contactable means preferably comprises a pair of generally parallel plates, such as metal plates, interconnected by a joining segment having an aperture through which the body part passes. The primary container-contactable means preferably includes means to enhance frictional engagement between said primary container-contactable means and an external lower sidewall of a container. The primary container-contactable means and the secondary container-contactable means preferably each comprise at least two container-contactable formations.

The body part of the trolley device preferably comprises one elongate length of tubing in light duty embodiments, whereas the body part preferably comprises a plurality, such as three, spaced apart generally parallel upright elongate lengths of tubing in heavy duty embodiments.

In order that the above and other aspects of the present invention may be illustrated, more easily appreciated and readily carried into effect, embodiments thereof will now be described, by way of non-limiting examples only, with reference to the accompanying drawings wherein:

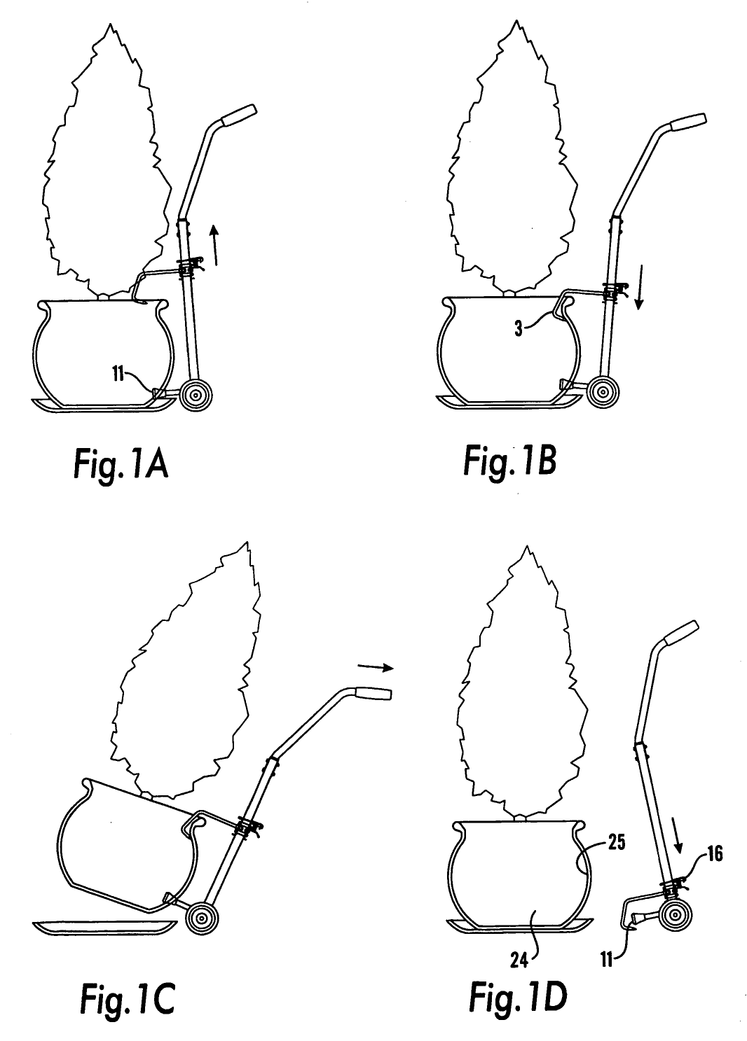

FIGS. 1A to 1D show use of one preferred trolley device according to the invention in connection with raising, moving and lowering an open-topped plant container;

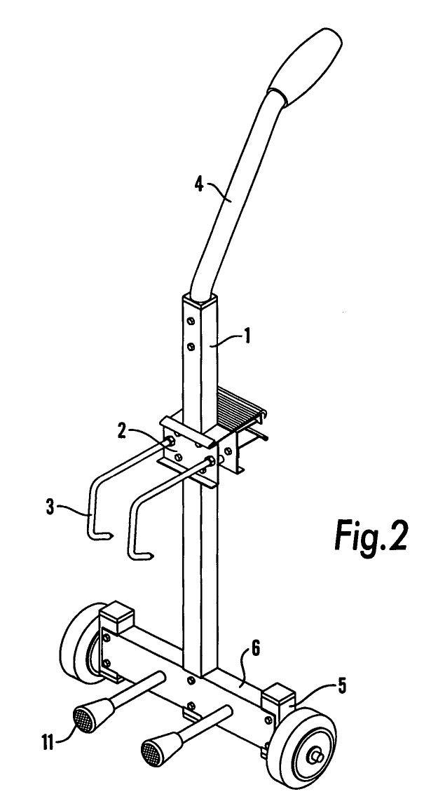

FIG. 2 is an isometric view of one preferred light-duty embodiment of the present invention;

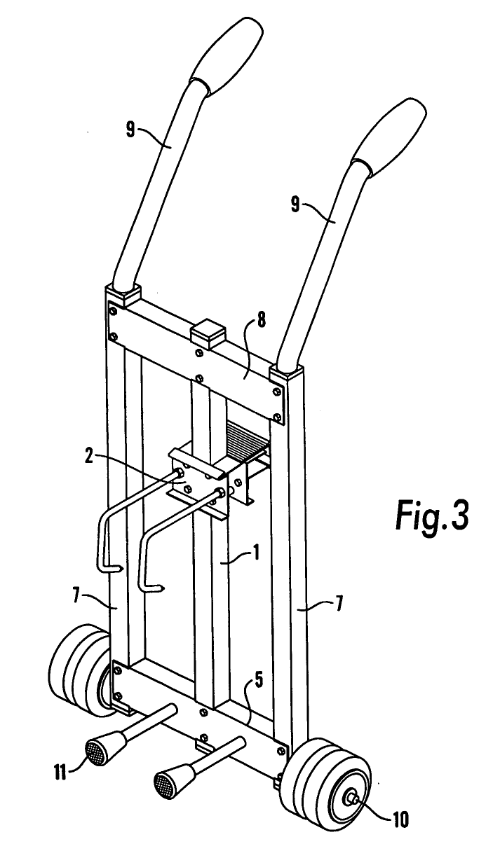

FIG. 3 is an isometric view of an alternative embodiment for more heavy-duty applications;

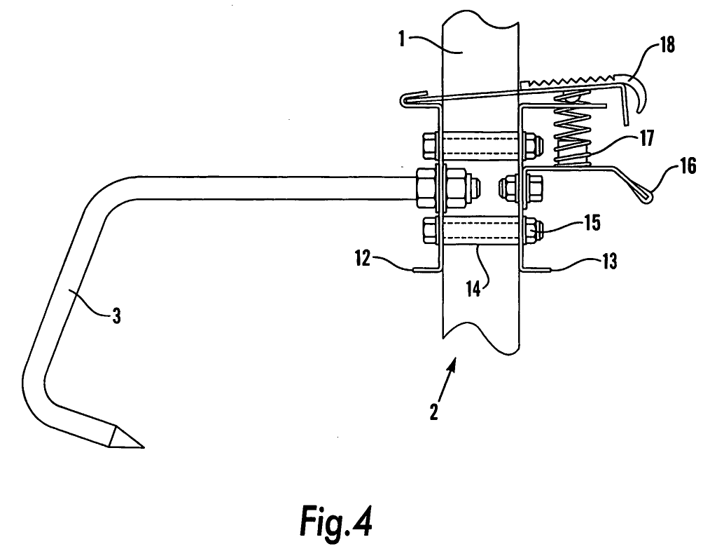

FIG. 4 is a part sectional elevation of one suitable form of secondary container-contactable means;

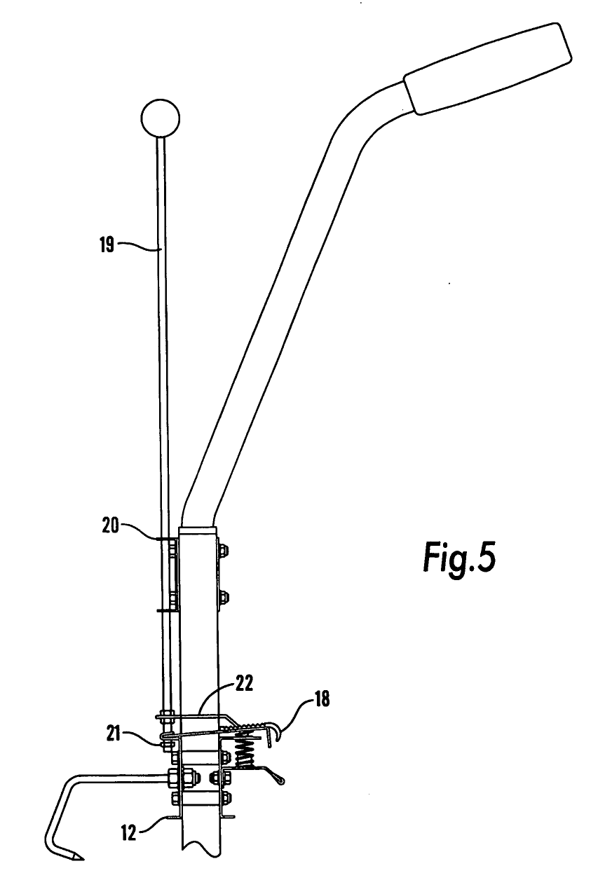

FIG. 5 is a part sectional elevation of a trolley device in either light or heavy duty form showing means for actuating displacement of the secondary container-contactable means;

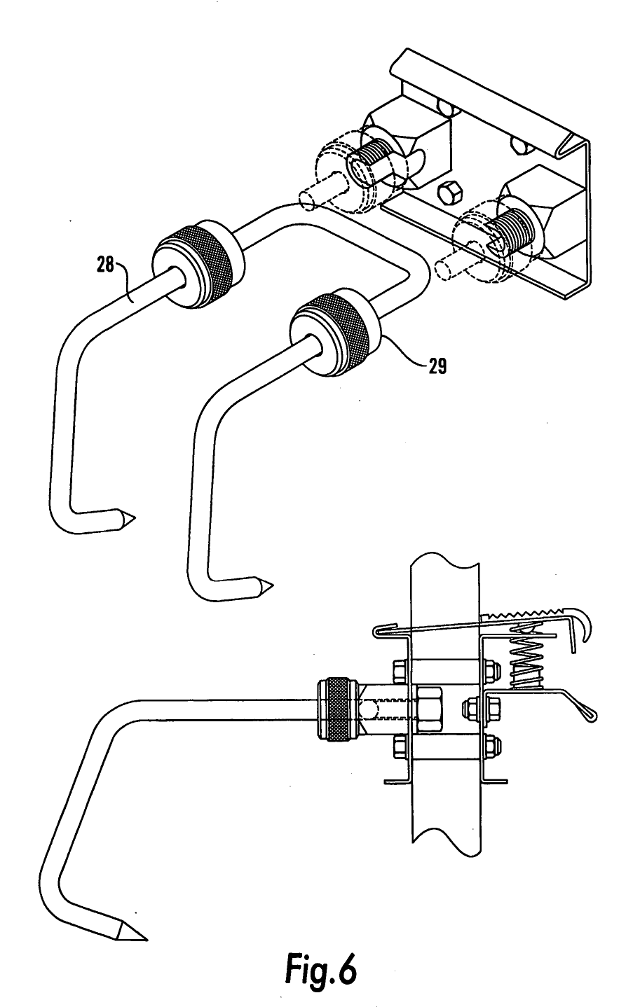

FIG. 6 shows two detailed views of an alternative container contactable part of the secondary container-contactable means,

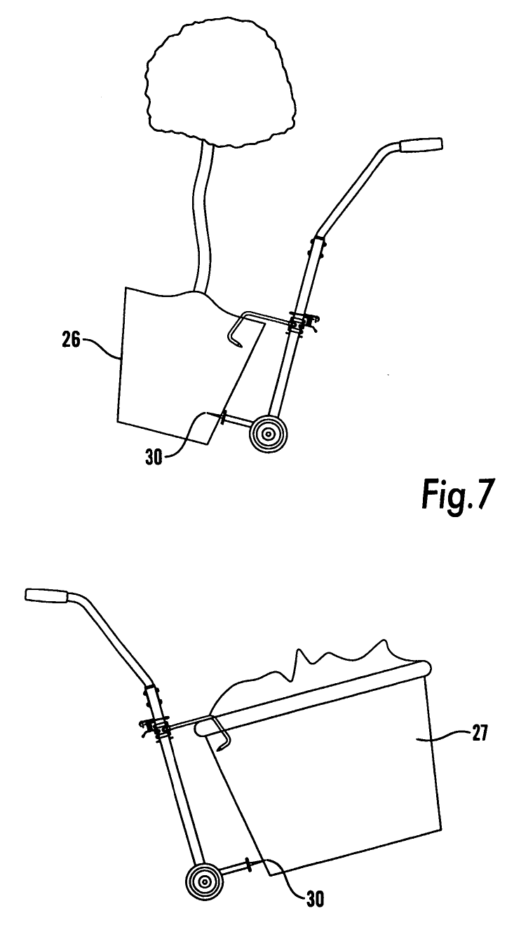

FIGS. 7(a) and 7 (b) show views of the trolley device carrying and moving different types of open-topped containers which need not incorporate a shrub or other plant material,

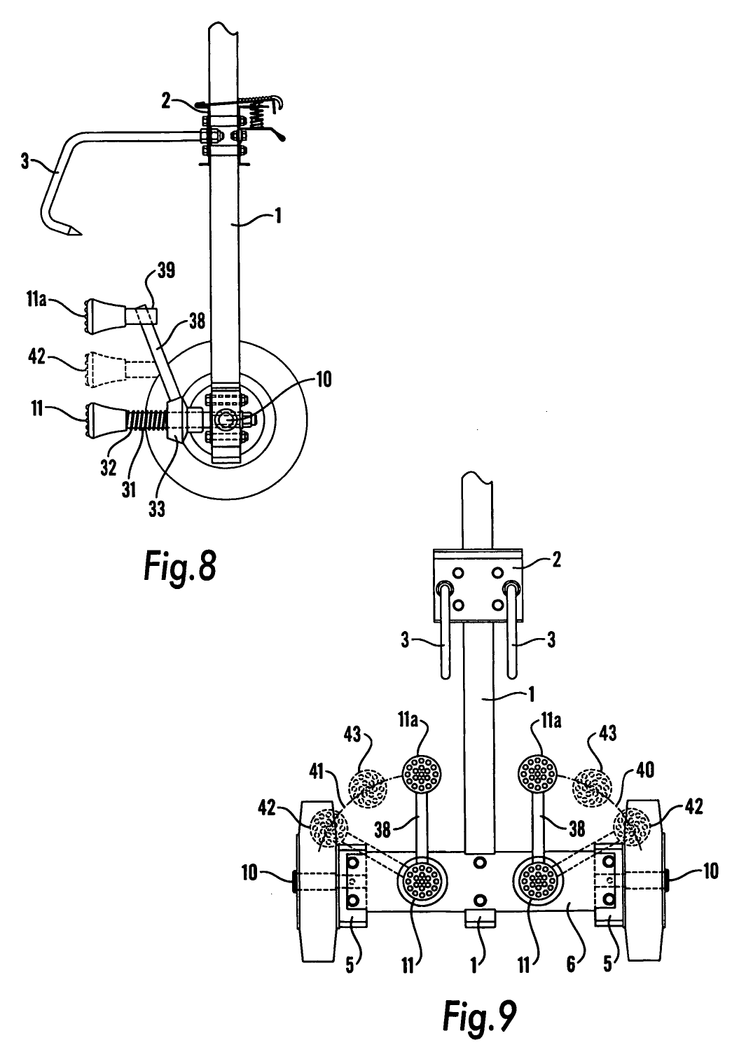

FIG. 8 depicts a part sectional view from one side of a modified light duty version of trolley device with additional adjustable primary container-contactable means,

FIG. 9 is a front elevation of that part of the modified trolley device shown in FIG. 8,

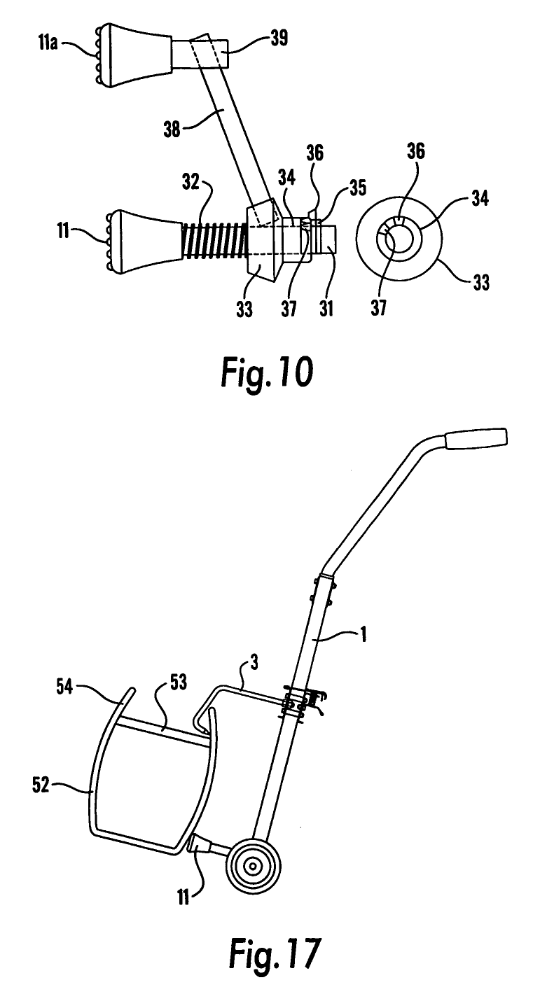

FIG. 10 is an enlarged detail of adjustable primary container-contactable means illustrated in FIGS. 8 and 9,

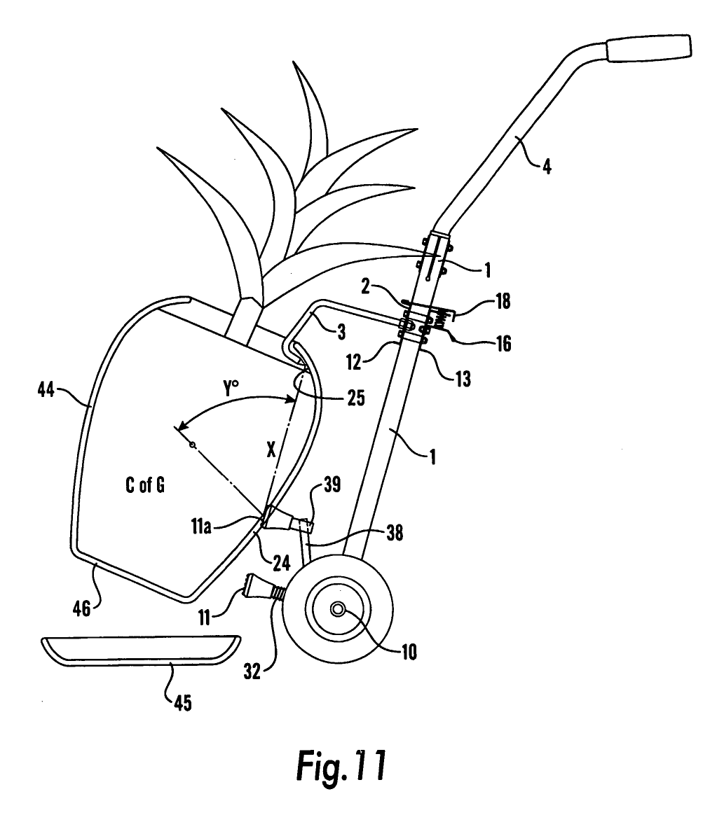

FIG. 11 shows use of the modified light duty version of trolley device, in a similar manner to that shown in FIG. 1C,

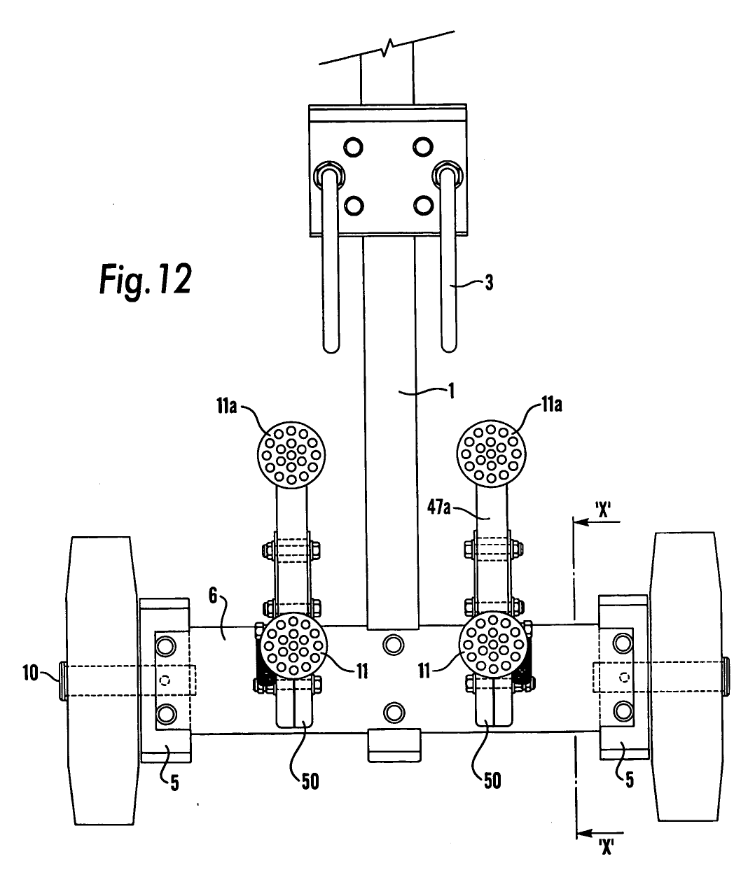

FIG. 12 shows a still futher embodiment of a light duty version, in which the primary container-contactable means are supplemented by additional container-contactable parts,

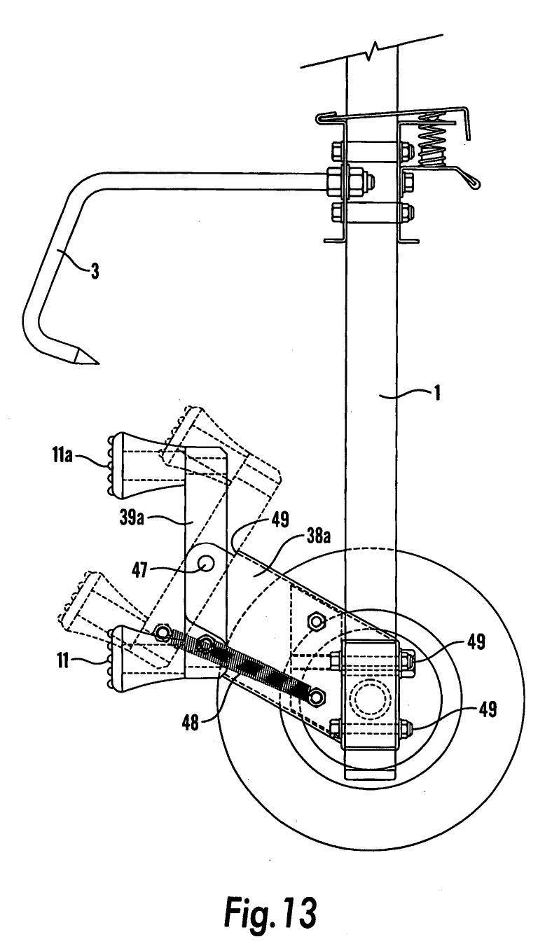

FIG. 13 is a sectional view along the line X-X of FIG. 12,

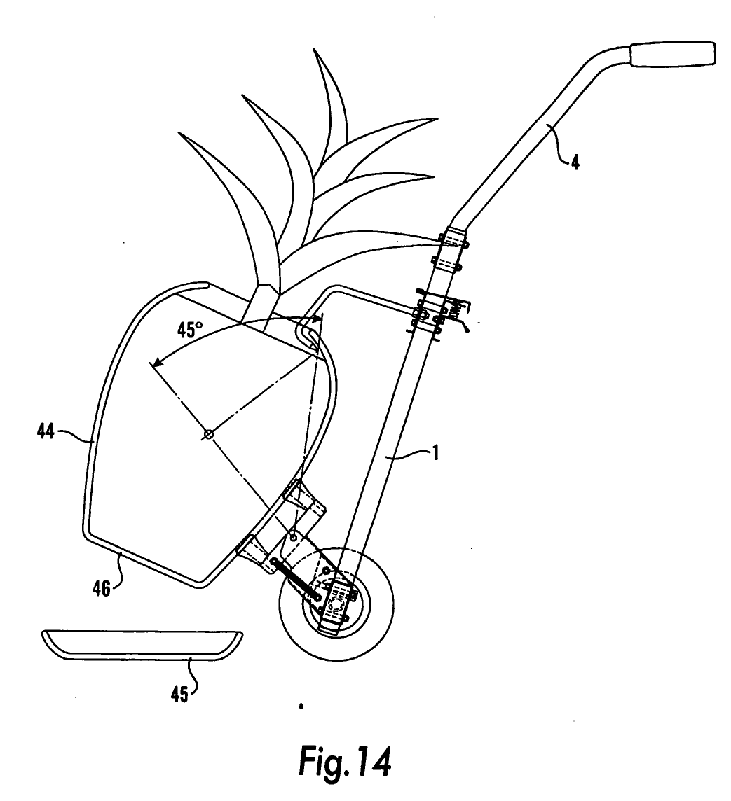

FIG. 14 shows a use of the FIG. 12 embodiment of FIG. 12,

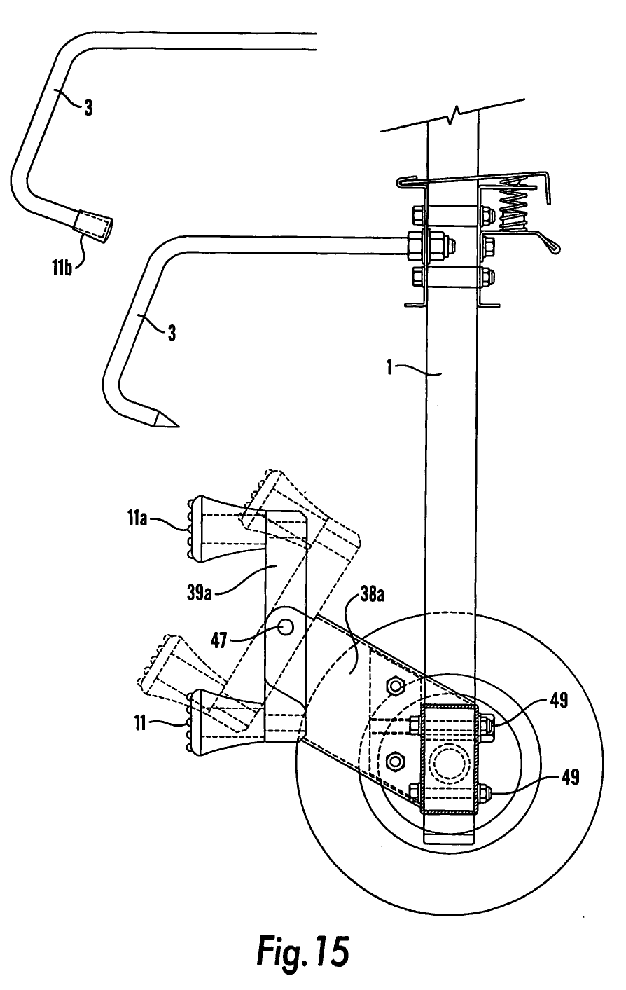

FIG. 15 shows a variation of the embodiment of FIGS. 12 and 13, and

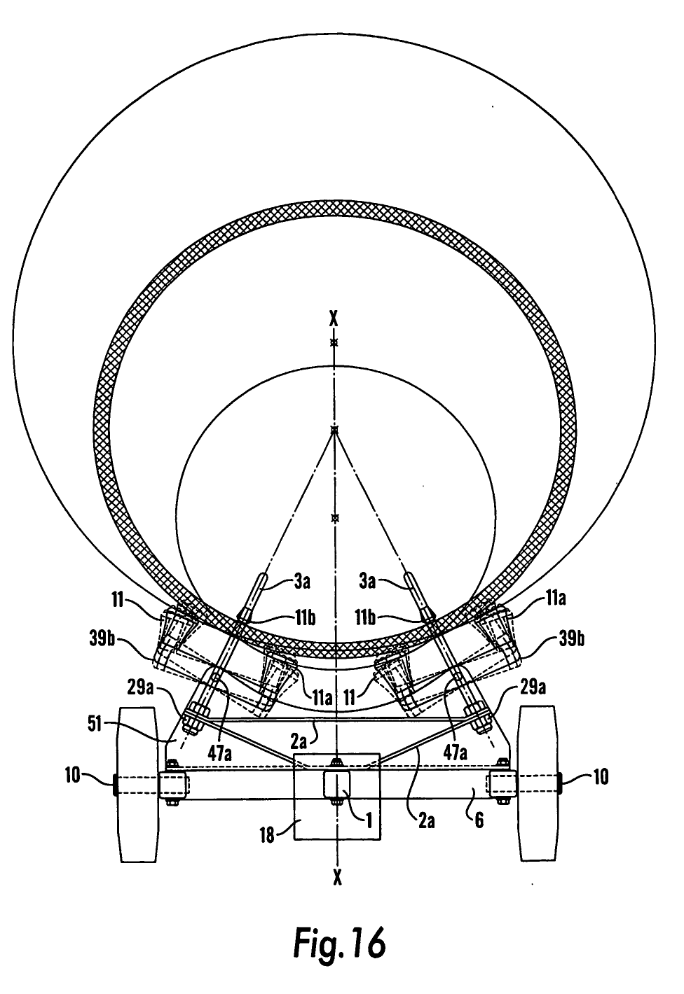

FIG. 16 shows a yet further construction of a trolley wherein the container-contactable formations of the primary container-contactable means are arranged to pivot within a horizontal plane.

Referring to the drawings and initially to FIGS. 1A to 1D, these illustrate a wheeled trolley device which allows for the lifting and moving of garden pots and similar articles of various diameters, shapes, heights, and weights with limited, if any, need for manual effort being applied to the pot itself. The wheeled trolley device attaches itself to one side of the pot only, by means of shaped hooks and rubber ferruled bars, eliminating the need for any type of lifting support beneath the base of the pot. The result is a container handling technique with minimum effort by the user.

FIGS. 2 & 3 show a bolted modular approach to the trolley assembly that allows it to be built either as a light duty unit or as a heavy duty unit, with many parts of light and heavy duty embodiments being interchangeable. The light unit has a body part in the form of a single central square tubular member 1 carrying the movable carriage assembly 2 with hooks 3 attached and one handle 4. For the heavy duty unit, the short square tubes carrying the axle 5 are removed from the lower stretcher sections 6 of the wheeled chassis and replaced with two side members 7 identical to the central tube 1 forming a rigid generally planar framework. Additional stretcher sections 8 are bolted across the top and two handles 9 attached instead of the central one. The moveable carriage assembly 2 remains on the central tube. Wheel axles 10 are reversible to allow either single or double wheels to be fitted, the latter providing a larger footprint on softer ground if required. The lower stretcher 5 of the wheeled chassis carries two fixed support bars and rubber pot protection ferrules 11 at their distant ends.

FIG. 4 shows the central square section tube 1 body part and the moveable carriage assembly 2 which adjusts for different heights of pots. It comprises a front plate 12 that carries the shaped hooks 3 and a back plate 13. These plates are held together with spacers 14 and bolts through, terminating with self-locking nuts 15, and act as a guide for the assembly. A bracket 16 is attached to the back plate 13 and serves as a lifting point for raising the moveable carriage assembly 2. It also acts as a support for the spring 17 which exerts an upward force to the underside of the locking plate 18. This plate is hinged at its front edge by being contained in a vee-shaped fold on the front plate 12. The arrangement results in a wedging action on the central square tube 1 and any downward movement of the hooks is prevented. Release of the sliding mechanism locking plate 18 is by downward pressure to its rear edge e.g. by foot or hand operation whereby the assembly will move down and lock again when pressure is removed.

FIG. 5 demonstrates an additional means for operating the moveable carriage assembly, supplementary to the previous method. It comprises a vertical operating rod 19, with knob attached, sliding in a bearing bracket 20. Its lower end passes through the edge of the locking plate 18 and the folded vee of the front plate 12 and terminates with a self-locking nut 21. Attached to the operating rod 19 immediately above the locking plate is a fork-shaped pressure plate 22 positioned by means of nuts on both sides and having its rear ends turned down to make contact with the upper surface of the locking plate 18. A downward force applied to the operating rod 19 in turn applies a force to the locking plate 18 and the moveable carriage assembly 2 with hooks attached moves down to its new position and automatically locks on release of pressure. An upward pull on the operating rod 19 allows the self locking nut 23 on the lower end of the rod to come in contact with the right-angled bend of the front plate 12. Movement upwards is accomplished by the locking plate 18 self releasing and locking again when movement ceases.

FIGS. 1A to 1D show the trolley in use. It is placed slightly forward of vertical to the side of the pot, with the hook mechanism in the upward position and the rubber ferruled support bars 11 in contact with an external lower surface 24 of the pot. The hooks 3 are then forced down into the soil, or against an internal upper surface 25, conveniently the inside edge of the pot, by either of the aforementioned methods—i.e. using the operating rod (when fitted) or by depressing the rear edge of the locking plate 18 by hand or by foot. Pivotal movement backwards about the axle of the wheeled chassis using the trolley handle(s) raises the primary and secondary container contactable means which lifts the pot clear of the ground, and also out of a saucer if one is present. It can now be wheeled away. After it has been lowered to the ground, release of the pot can also be achieved in two ways, either by pulling upward on the operating rod or by lifting the bracket 16 by foot or by hand. For parking and user safety the moveable carriage can be lowered to its maximum limit whereby the hooks will pass between the support bars and be protected. The trolley will now stand at rest in the near vertical position.

An alternative hook attachment is shown in FIG. 6. If hooks of a different shape are required for special purposes then a collet system can be fitted. The double hook 28 is made from one-piece high tensile spring wire and with collets nuts 29 in place it can be quickly attached as shown.

With reference to FIG. 7a, shrubs and the like located in a non-rigid container 26 can be lifted and moved more efficiently by replacing the rubber ferrules with a hard pointed alternative 30 to achieve a better grip.

With reference to FIG. 7b, plastic garden rubbish containers 27 with semi-rigid surfaces can also be moved with embodiments of the present trolley device.

A convenient trolley device is thus provided which enables one operative with the minimum of effort to lift relatively heavy open topped containers and move them to almost any required alternative position. A principal advantage stems from the absence of any part of the device to be intentionally located underneath a container, and the trolley device being capable of completing the lifting task without any need initially to partially raise or pivot the container manually.

Referring to FIGS. 8 to 10, a more versatile arrangement of light duty embodiment is shown although the modifications effected therein are equally applicable to and could easily be incorporated within the heavier duty type of device illustrated in and described above with reference to FIG. 3. In these figures, the primary container-contactable means now includes a movable auxiliary container-contactable part including a spigot 39 connected to a connector 38 and which spigot is provided with an auxiliary contacting rubber ferrule 11a. This rubber ferrule corresponds in all material respects with the ferrule 11 described hereinabove. The ferrules 11, 11a incorporate a plurality of projections (not referenced) to assist in the frictional contact and engagement with an outer surface part of the container, such as a container 44 of the ‘Ali-Baba’ type shown in FIG. 11. In such modified device, a spigot 31 projects from and is rigidly affixed to the lower stretcher section 6, with a rubber ferrule 11 at the far end of such spigot. In these respects the arrangement is identical to the embodiments shown in and described with reference to FIG. 2. The modification comprises a spring biased boss 33 having an integral collar 34 rotatably mounted to a limited extent upon the spigot 31. The boss and collar are integrally formed and extend around a common central bore through which the spigot 31 passes. The spigot 31 includes, at its end near or adjacent the lower stretcher section 6, a projecting dowel 35 adapted to engage one of three slots 36, 37 formed in the collar and in which the dowel can be seated.

A connector 38, such as a short length of metal tubing, is mounted in the boss 33 to extend at an acute angle relative to the spigot 31 and a secondary shorter spigot 39 is affixed to the connector 38 such that spigots 31, 39 and hence ferrules 11a, 11 extend in parallel away from the device, and at an angle of some 90° relative to the vertical body part 1 when the device is in its upright position shown in FIG. 8. Spring loading off the boss 33 by spring 32 causes a positive engagement between dowel 35 and either of the slots 36, 37 located in the collar. The auxiliary container-contactable part 11a can thus be rotated about an arc 40, 41 shown in FIG. 9 in which a rest position is depicted at 42, and an intermediate position is depicted at 43 before the ferrule 11a reaches its intended position of use shown by the more solid lines of parts 38, 39 and 11a in FIGS. 8 and 9. The rest position depicted at 42 may, if required be used as a parking or non-operational position for the auxiliary contacting part 11a. In order to effect a change of position from what may be a parking position 42, through the intermediate position 43 to the operational position (in that the part 11a is intended to come into contact with an external lower surface part of a container), the boss 33 can be grasped manually, pulled forward against the spring resistance, rotated and released whereby the projecting dowel is released from slot 37 in the collar 34 and caused to engage the other provided slot 36. The secondary container-contactable means is unaffected in this modified version.

Referring to FIG. 11, the modified light duty version of the device is depicted in use. It is apparent that for some containers of a particular shape or sidewall profile, the leverage, transportation and release of containers by the device is facilitated or improved if primary container-contactable means present can be raised even further above ground level compared to the level of fixed position such means previously described and illustrated. The auxiliary contacting parts, in the operational position, are raised of the order 100 mm above the position of the already present primary container-contactable means. Ability to engage, transfer and reposition filled pots of the ‘Ali-Baba’ sidewall profile shown in FIG. 11, is improved. The improvement also applies to similar pots where the ratio between height and diameter exceed 1-1, by moving the centre of gravity away from the line X (FIG. 11) and the lower contacting means. This effectively increases the angle Y (FIG. 11), shortens the length of the line X and provides a more even load distribution onto the hooks forming part of the secondary container-contactable means, and the ferrules/spigots utilised as components of the primary container-contactable means.

In the FIG. 12 arrangement, the primary container-contactable means is further modified by the provision, in total, of four separate container-contactable formations 11 and 11a wherein two such formations, in the nature of rubber ferrules incorporating a plurality of friction assisting raised projections, are provided at either end of a pivot arm 39a. This pivot arm is mounted for limited pivotal movement about a pivot 47 provided by way of pivot bush 47a between opposed plates 38a of a bracket 50 formed from sheet metal channel sections. The brackets are rigidly affixed, e.g. by means of bolts 49, to the lower stretcher section, and project outwardly from the body portion 1 at an inclined angle.

The pivot arm 39a is spring biased by spring 48 such that before use and when the body portion 1 is upright as depicted in FIG. 13, the pivot arm 39a is generally or substantially parallel to but spaced from the said body part. In this position, a gap or spacing between the rear surface of the pivot arm 39a and an adjacent edge of the channel section bracket 50, provides for the pivotal movement and a stop or rest position in abutment between that rear surface of the pivot arm and edge of the section. This is depicted by the two positions shown of the pivot arm in FIG. 13, and in FIG. 14 wherein an open-topped container of the ‘Ali-Baba’ type has been lifted out of its companion saucer by tilting the body part 1 backwards a few degrees from the upright.

This alternative container support system, as shown in FIGS. 12 to 14 provides four contact points within the primary container-contactable means, to abut corresponding lower sidewall external portions of the container. A particular benefit is that this arrangement aligns automatically to various sidewall contours without the need for manual adjustments.

This arrangement could be fashioned into the heavy duty version of device without difficulty.

Referring to FIG. 15, the arrangement of trolley device corresponds substantially with the embodiments depicted in and described above with reference to FIGS. 12 and 13. The difference is that the spring (48—FIG. 13) is omitted, and in the secondary container-contactable means, the projecting arms are provided with a rubber ferrule 11b in place of the sharp point. The variation of FIG. 15 may function more effectively than the embodiment of FIGS. 12 and 13, with an improved self-aligning function of the vertically pivoting arm of the primary container-contactable means.

Referring to FIG. 16, a plan view of the modified trolley device is depicted, with an array of three different pot sizes. Where the constructional features correspond to those of above described embodiments, the same reference numerals have been used. In this preferred embodiment, the primary container-contactable means is composed of a pair of horizontally mounted and horizontally pivoting pivot arm 39b. Each individual pivot arm 39b is provided with a pair of container-contactable rubber ferrules 11, 11a which are adapted to engage an outer lower surface of a pot container. The horizontal pivot arms 39b are mounted upon a lower support bracket 51 by means of pivots 47a. The lower support bracket in turn is rigidly affixed to the lower chassis stretcher 6 to project outwardly therefrom, and which is spaced above ground when the device is positioned with its handle upright. In consequence, the rubber ferrules 11 and 11a of the primary container-contactable means are similarly spaced above ground when the device is in the same position, and operate in a self-aligning fashion to contact outer lower surface parts of the container when the device is presented to a suitable container and caused to engage same for lifting and moving.

In this embodiment, the secondary (upper) container-contactable means are also modified in that a triangulated framework array 2a is fastened to the corresponding moveable mounting plate 18, and the arms 3a bolted thereto at 29a project convergently so that a notional continuation of their length in a direction away from the device intersects a diameter along the line X-X of a pot container having circular cross-section. The modified arms are provided with rubber ferrules 11b, of smaller size than ferrules 11, 11a, at their remote ends adapted to contact an upper interior surface of the container. Such ferrules can be preferred for pots constructed of plastic which might be damaged by a sharp point, without interfering in their ease of use upon depressing these ends into and below the level of earth, compost or other material optionally present in the pot.

As depicted in FIG. 15, it is also preferred that the vertical plane in which the arms 3a lie, intersects the pivot point 47a of the pivoting arms 39b and this is ideally positioned mid-way along the length of the respective pivot arm. Such an arrangement provides better stability for larger diameters of pots and helps to reduce stresses to the pot by splitting the load into two areas instead of one.

Although described with respect to open-topped containers such as garden containers, the present invention is equally advantageous in manoeuvring many types of container whether open, as in the case of garden containers or closed, such as drums or barrels, having a rim of sufficient depth to be engaged by hooks 3,28. An example is illustrated in FIG. 17 in which the embodiment of FIG. 1 is used to move a barrel 52 having a closed top 53 and a rim 54 of sufficient depth to be engaged by hooks 3.

1. A trolley device capable of lifting and moving a container from an upright rest position, the device comprising a body part having handle means and means which permit movement of the device along a surface, the body part having container-contactable means which consist of primary and secondary container-contactable means, the primary container-contactable means being spaced above ground when said body part is upright and including at least one container-contactable part projecting outwardly from the body part and adapted to abut an external lower side wall of such a container, the secondary container contactable means spaced above said primary container-contactable means when said body part is upright and including at least one container-contactable part adapted to abut an internal upper side wall of the container, said body part capable of pivotal movement to raise and lower both said container-contactable means.

2. A trolley device as claimed in claim 1, wherein one of the contain contactable means is moveable relative to the other along the body part.

3. A trolley device as claimed in claim 1, wherein the secondary container-contactable means is slidably moveable with respect to the body part and comprises a moveable carriage incorporating a releasable clamp operable to provide a range of stop positions between uppermost and lowermost positions of the clamp.

4. A trolley device as claimed in claim 3, wherein the clamp mechanism is releasably spring urged in frictional engagement with the body part.

5. A trolley device as claimed in claim 2 wherein the secondary container-contactable means is moveable along the body part towards and away from the primary container-contactable means.

6. A trolley device as claimed in claim 5 wherein the moveable secondary container-contactable means is adapted to be displaced along the body part by a hand or foot operable member or by actuation means in the region of the handle means.

7. A trolley device as claimed in claim 1 wherein the secondary container-contactable means includes at least one hook member adapted to engage an upper internal sidewall of said open topped container below an uppermost internal rim thereof.

8. A trolley device as claimed in claim 7 wherein a pair of hook members are provided whose ends project towards the body part.

9. A trolley device as claimed in claim 8 wherein the secondary container-contactable means further comprise a pair of generally parallel plates interconnected by a joining segment having an aperture through which the body part passes.

10. A trolley device as claimed in claim 1 wherein the body part includes or is otherwise attached to a wheeled chassis.

11. A trolley device as claimed in claim 10, wherein the primary container-contactable means is mounted upon the chassis and project outwardly thereof.

12. A trolley device as claimed in claim 1 wherein the primary container-contactable parts are fitted with removable and replaceable means to assist frictional engagement between said primary means and said external sidewall of a container.

13. A trolley device as claimed in claim 1 wherein the primary container-contactable and secondary container-contactable means each comprise at least two container-contactable surface members.

14. A trolley device as claimed in claim 1 wherein the primary container-contactable means further includes a moveable auxiliary container-contactable part.

15. A trolley device as claimed in claim 14 in which the auxiliary part is moveable rotationally about said at least one container-contactable part.

16. A trolley device as claimed in claim 14 wherein the said one and the auxiliary container-contactable parts extend in parallel away from the body part.

17. A trolley device as claimed in claim 1 wherein the primary container-contactable means comprises at least two spaced brackets mounted upon a lower section of the device and each bracket incorporating a pivotally mounted arm upon which a pair of container-contactable formations are provided, such that at least four container-contactable formations are present.

18. A trolley device as claimed in claim 1, wherein the primary container-contactable means comprises at least two spaced pivot arms mounted in a horizontal plane when the device is upright, both said pivot arms provided at or in the region of their ends with container-contactable formations.

19. A trolley device as claimed in claim 1 wherein the container-contactable formations of the secondary container-contactable means are mounted convergently.

20. A trolley device as claimed in claim 1, wherein the container-contactable formations of the secondary container-contactable means are provided with flexible ferrules.

21. A trolley device as claimed in claim 1, wherein the body part comprises three spaced apart generally parallel upright elongate lengths of tubing.

22. A trolley device as claimed in claim 1 in combination with a container, preferably an open-topped container.

23. A trolley device as claimed in claim 1 wherein the clamp mechanism is laterally turnable about the body part.
